(19) United States
(12) Patent Application Publication
(10) Pub. No.: US 2017/0247224 A1
(43) Pub. Date: Aug. 31, 2017

(54) TARGET FLOOR REGISTRATION UNIT AND A METHOD OF USING THE SAME

(71) Applicant: Otis Elevator Company, Farmington, CT (US)

(72) Inventors: Tadeusz Pawel Witczak, Bethel, CT (US); Arthur Hsu, South Glastonbury, CT (US); Jose Miguel Pasini, Avon, CT (US); David Ginsberg, Granby, CT (US)

(21) Appl. No.: 15/437,538

(22) Filed: Feb. 21, 2017

Related U.S. Application Data
(60) Provisional application No. 62/299,950, filed on Feb. 25, 2016.

(51) Int. Cl. B66B 1/46; B66B 1/34; B66B 5/00

(52) U.S. Cl. CPC B66B 1/468; B66B 5/0012; B66B 1/3446; B66B 2201/4615; B66B 2201/103; B66B 2201/463

(57) ABSTRACT

A target floor registration unit for use in an elevator system including a unit controller configured to receive assignment information, a user detection device operably coupled to the controller; wherein the user detection device is configured to determine whether a user is present at the target floor registration unit, and a display part; the display part configured to dynamically display the assignment information based in part on whether the user is present at the target floor registration unit.

### TECHNICAL FIELD OF THE DISCLOSED EMBODIMENTS

The present application is a nonprovisional patent application, which claims priority to U.S. Patent Application Ser. No. 62/299,950 filed Feb. 25, 2016, which is herein incorporated in its entirety.

### TECHNICAL FIELD OF THE DISCLOSED EMBODIMENTS

The present disclosure generally relates to elevator systems, and more particularly, the present disclosure relates to a target floor registration unit and a method of using the same.

### BACKGROUND OF THE DISCLOSED EMBODIMENTS

Generally, target floor registration units (e.g., elevator kiosks) use a static time value for displaying elevator assignments on the screen which may lead to lower system performance, such as delays and user confusion, when the next user sees a previous assignment on the screen and waits for an input screen to place a new call. In other instances the user may be distracted and miss the assignment, in which case the target floor registration unit may have already switched to an input screen; thus causing the user to reenter the desired elevator call. Accordingly, there exists a need for a target floor registration unit to dynamically show an assignment screen to improve system performance.

### SUMMARY OF THE DISCLOSED EMBODIMENTS

In one aspect, an elevator system is provided. The elevator system includes an elevator controller, a target floor registration unit operably coupled to the elevator controller, and a user detection device operably coupled to the target floor registration unit. The user detection device is configured to determine whether a user is present at the target floor registration unit. The target registration unit is configured to receive assignment information from the elevator controller, and dynamically display the assignment information based in part on whether the user is present at the target floor registration unit.

In any embodiment, the elevator system further includes an interface operably coupled to the elevator controller and the target floor registration unit, wherein the interface device is configured to allow communications between the elevator controller and the target floor registration unit.

In any embodiment of the elevator system, the target floor registration unit further includes a registration operation part and a display part. In an embodiment, the registration operation part is integrated within the display part.

In any embodiment of the elevator system, the user detection device is chosen from a group consisting of: a proximity sensing device, a device capable of capturing an image, a pressure sensing device, and a user authorization device. In any embodiment of the elevator system, the user detection device is disposed within the target floor registration unit.

In one aspect, a method of operating a target floor registration unit including a user detection device operably coupled thereto to display assignment information thereon is provided. The method includes determining whether a user has been detected within an idle duration of time, displaying an input screen to allow the user to enter an elevator call if the user has been detected within the idle duration of time, determining whether the detected user has successfully registered the elevator call, and displaying an assignment screen if the user successfully registered the elevator call.

In any embodiment of the method, determining whether a user has been detected includes operating the user detection device to determine the presence of the user. In any embodiment of the method, determining whether a user has been detected within an idle duration of time further includes entering an energy saving mode if it is determined that a user has not been detected within the idle duration of time. In any embodiment of the method, the idle duration of time is approximately 5 minutes.

In any embodiment of the method, displaying an assignment screen if the user successfully registered the elevator call further includes displaying the input screen after a user is not detected for at least an operational duration of time. In an embodiment, the operational duration of time is greater than or equal to approximately 10 seconds.

In one aspect, a target floor registration unit for use in an elevator system is provided. The target floor registration unit includes a unit controller configured to receive assignment information, a user detection device operably coupled to the controller; wherein the user detection device is configured to determine whether a user is present at the target floor registration unit, and a display part; the display part configured to dynamically display the assignment information based in part on whether the user is present at the target floor registration unit. In any embodiment of the target floor registration unit, the target floor registration unit further includes a registration operation part operably coupled to the unit controller. In an embodiment, the registration operation part is integrated within the display part.

In any embodiment of the target floor registration unit, the user detection device is chosen from a group consisting of: a proximity sensing device, a device capable of capturing an image, a pressure sensing device, and a user authorization device.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of an elevator system according to an embodiment of the present disclosure;

FIG. 2 is a schematic diagram of a target floor registration unit according to an embodiment of the present disclosure; and

FIG. 3 is a schematic flow diagram of a method of operating a target floor registration unit to display assignment information.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

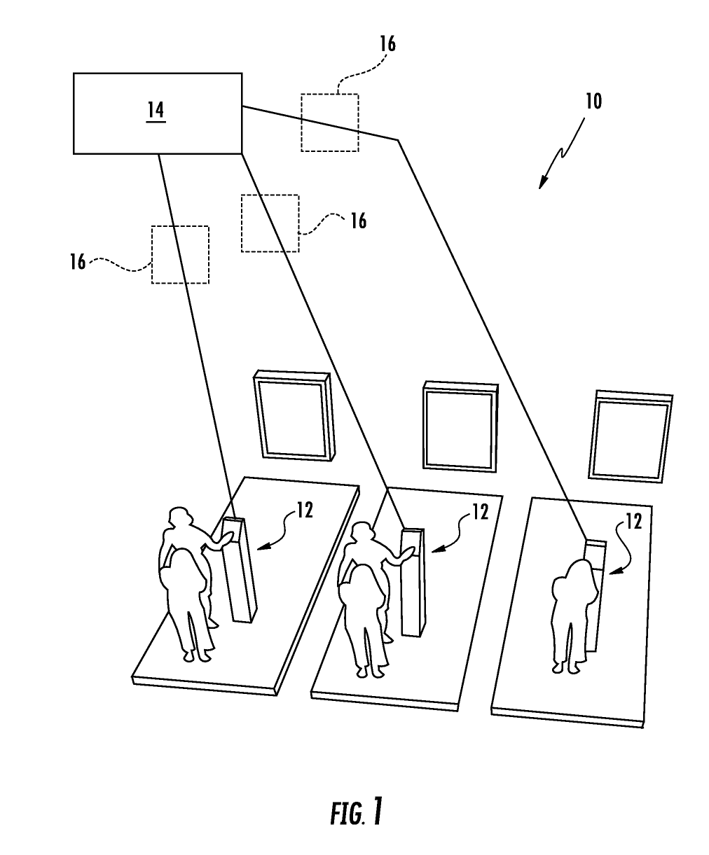

FIG. 1 shows an embodiment of an elevator system, generally indicated at 10. The elevator system 10 includes a target floor registration unit 12 which may be located at and/or near the elevator landings on respective floors. It will be appreciated that the target floor registration unit 12 may also be located in other locations, such as near the entrance of a building, and in main communication paths (e.g., a lobby area) to name a couple of non-limiting examples. The target floor registration unit 12 is operably coupled to an elevator controller 14. In some embodiments the target floor registration unit 12 is operably coupled to the elevator controller 14 via an interface device 16. The target floor registration unit 12 is configured to allow a user to enter a desired floor of travel, and display the elevator car assigned by the elevator controller 14. The elevator controller 14 is configured to manage all aspects of an elevator located within the building.

When a target floor is registered using the target floor registration unit 12, the elevator controller 14 may assign the most suitable elevator car (e.g., the elevator car that can be brought to the target floor in the shortest time possible) based on the registered target floor registration information, and disclose information about the assigned elevator car and transmit it to the target floor registration unit 12.

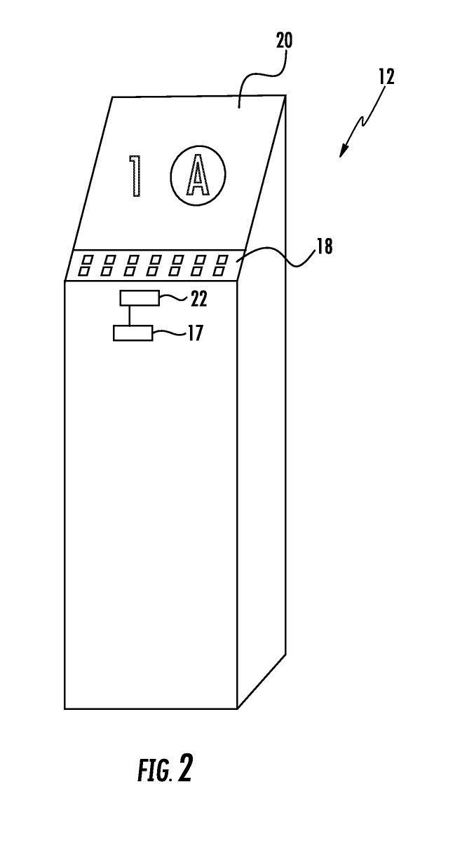

As shown in FIG. 2, the target floor registration unit 12 includes a unit controller 17 operably coupled to a registration operation part 18 integrated within a display part 20, for example by using a touch screen display to allow the user to operate numerical icons for selection of a target floor. The display part 20 displays pieces of assignment information assigned by the elevator controller 14, such as the target floor, elevator bay, hoistway door, car identification, visual guidance (e.g., a map to locate the boarding zone and/or hoistway door), and in some instances the waiting time to name a few non-limiting examples. It will be appreciated that the display part 20 may also project the assignment information on a surface (e.g., a screen or wall), or project the assignment information as a hologram. In some embodiments, the target floor registration unit 12 includes the registration operation part 18 for registering a target floor using numeric keys separate from or integrated into the display part 20. In other embodiments, the registration operation part 18 may include a voice recognition device configured to accept voice commands.

In an embodiment, the target floor registration unit 12 includes a communication module (not shown) operably coupled to the unit controller 17, the communication module configured to transmit the assignment information to a secondary device. For example, once the target floor registration unit 12 receives the assignment information from the elevator controller 14, the communication module may transmit the assignment information to the secondary device, such as a mobile phone, tablet device, smart watch, etc. to name a few non-limiting examples, via near field communication, BLUETOOTH, Wi-Fi, etc. to name a few non-limiting examples.

The target floor registration unit 12 further includes a user detection device 22 disposed therein. In another embodiment, the user detection device 22 is in communication with the target floor registration unit and in close proximity thereto. The user detection device 22 is configured to determine whether a user is currently present at and/or using the target floor registration unit 12.

In one embodiment, the user detection device 22 includes a proximity sensing device, for example a passive infrared sensor. In this embodiment, the proximity sensor is able to detect whether a user is presently standing at the target floor registration unit 12.

In another embodiment, the user detection device 22 includes a device capable of capturing an image, for example a video camera or a time-of-flight camera to name a couple of non-limiting examples. In this embodiment, the user detection device 22 may be positioned and configured to focus on the gaze of the user to determine whether the user is looking at the display part 20 of the target floor registration unit 12. The user detection device 22 may also be able to three-dimensionally track the movement of the user to determine whether the user is approaching or walking away from the user detection device 22. It will be appreciated that the captured video may be processed by the unit controller 17, and an output may be used as a parameter for defining the best assignment.

In another embodiment, the user detection device 22 includes a pressure sensing device, for example a weight mat sensor, located adjacent to the target floor registration unit 12. The pressure sensing device is configured to detect movement of the user by sensing pressure placed on the device by weight. It will be appreciated that the pressure sensing device output may be used as a parameter for defining the best assignment.

In another embodiment, the user detection device 22 includes a user authorization device, such as a card reader security device to name one non-limiting example. In this embodiment, the card reader security device is able to detect the presence of a user based on whether the user requests authorization to use the target floor registration unit 12.

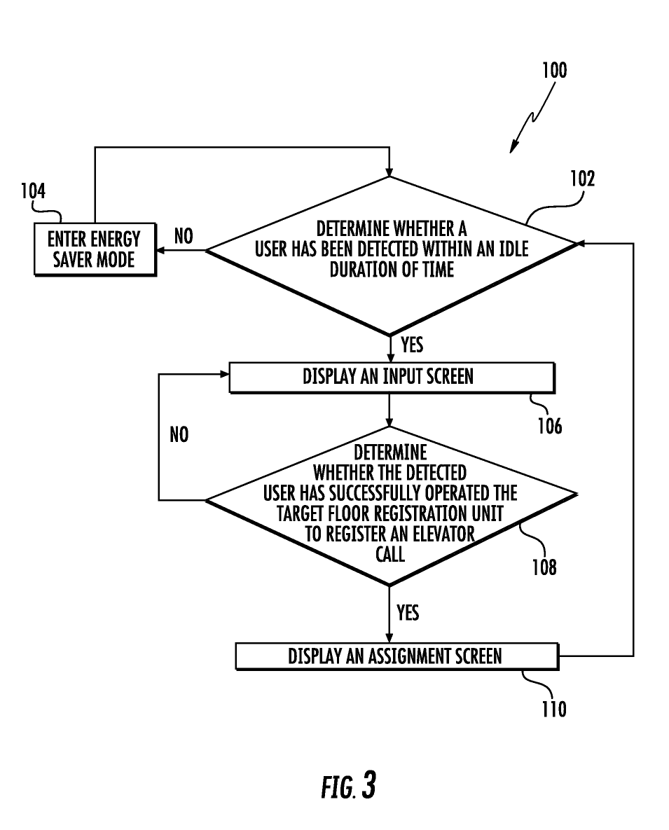

FIG. 3 illustrates a method of displaying assignment information on a target floor registration unit 12, the method generally indicated at 100. The method 100 includes step 102 determining whether a user has been detected within an idle duration of time. In an embodiment, the idle duration of time is approximately 5 minutes. It will be appreciated that the idle duration of time may be greater than or less than approximately 5 minutes. In an embodiment, determining whether a user has been detected includes operating the user detection device 22 to determine the presence of the user.

If a user has not been detected within the idle duration of time, the display part 20 of the target floor registration unit 14 may enter an energy saving mode, in step 104. For example, the energy saving mode may turn off peripheral electronics, such as a keypad light, authorization readers, etc., before turning off the display part 20; however, a visual indicator may remain operational to indicate the target floor registration unit is functional. If a user is detected by the target floor registration unit 12 within the idle duration of time, the target floor registration unit 12 displays an input screen, in step 106, to allow the user to select the desired floor of travel.

Once the user selects the desired floor of travel, the target floor registration unit 12 determines whether the detected user has successfully registered an elevator call, in step 108. If the user has not successfully registered the elevator call, the target floor registration unit 12 returns to step 106 of displaying an input screen.

If the user successfully registered the elevator call in step 108, the target floor registration unit 12 displays an assignment screen, in step 110, informing the user which elevator will service the elevator call, and may inform the user to move towards the designated elevator. The target floor registration unit 12 will continue to display the assignment screen until a new user is detected by the user detection device 22. In some embodiments, the target floor registration unit 12 may return to the input screen after a user is not detected for at least an operational duration of time. In an embodiment, the operational duration of time is greater than or equal to approximately 10 seconds. It will be appreciated that the operational duration of time may be less than 10 seconds.

It will therefore be appreciated that the present elevator system 10 includes a target floor registration unit 12 including a user detection device 22 capable of detecting the presence of a user, and dynamically showing an assignment screen on the display part 20 until a new user approaches the target floor registration unit 12; thus, increasing system efficiency, user confidence, and boarding correctness.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. An elevator system comprising:
an elevator controller;
a target floor registration unit operably coupled to the elevator controller; and
a user detection device operably coupled to the target floor registration unit; wherein the user detection device is configured to determine whether a user is present at the target floor registration unit;
wherein the target registration unit is configured to:
(a) receive assignment information from the elevator controller; and
(b) dynamically display the assignment information based in part on whether the user is present at the target floor registration unit.

2. The elevator system of claim 1, further comprising an interface operably coupled to the elevator controller and the target floor registration unit, wherein the interface device is configured to allow communications between the elevator controller and the target floor registration unit.

3. The elevator system of claim 1, wherein the target floor registration unit further comprises a registration operation part and a display part.

4. The elevator system of claim 3, wherein the registration operation part is integrated within the display part.

5. The elevator system of any of claim 1 wherein the user detection device is chosen from a group consisting of: a proximity sensing device, a device capable of capturing an image, a pressure sensing device, and a user authorization device.

6. The elevator system of claim 1 wherein the user detection device is disposed within the target floor registration unit.

7. A method of operating a target floor registration unit including a user detection device operably coupled thereto to display assignment information thereon, the method comprising:
(a) determining whether a user has been detected within an idle duration of time;
(b) displaying an input screen to allow the user to enter an elevator call if the user has been detected within the idle duration of time;
(c) determining whether the detected user has successfully registered the elevator call; and
(d) displaying an assignment screen if the user successfully registered the elevator call.

8. The method of claim 7, wherein determining whether a user has been detected includes operating the user detection device to determine the presence of the user.

9. The method of claim 7, wherein step (a) further comprises entering an energy saving mode if it is determined that a user has not been detected within the idle duration of time.

10. The method of claim 7, wherein the idle duration of time is approximately 5 minutes.

11. The method of claim 7, wherein the step (d) further comprises displaying the input screen after a user is not detected for at least an operational duration of time.

12. The method of claim 11, wherein the operational duration of time is greater than or equal to approximately 10 seconds.

13. A target floor registration unit for use in an elevator system, the target floor registration unit comprising:
a unit controller configured to receive assignment information;
a user detection device operably coupled to the controller; wherein the user detection device is configured to determine whether a user is present at the target floor registration unit; and
a display part; the display part configured to dynamically display the assignment information based in part on whether the user is present at the target floor registration unit.

14. The target floor registration unit of claim 13, further comprising a registration operation part operably coupled to the unit controller.

15. The target floor registration unit of claim 14, wherein the registration operation part is integrated within the display part.

16. The target floor registration unit of claim 13, wherein the user detection device is chosen from a group consisting of: a proximity sensing device, a device capable of capturing an image, a pressure sensing device, and a user authorization device.
